(19) United States
(12) Patent Application Publication
(10) Pub. No.: US 2007/0253890 A1
(43) Pub. Date: Nov. 1, 2007

(54) Highly Efficient Material Spraying Type Carbon Nanostructure Synthesizing Method and Apparatus

(76) Inventors: Yoshikazu Nakayama, Hirakata-city (JP); Takeshi Nagasaka, Shinagawa-ku (JP); Toru Sakai, Shinagawa-ku (JP); Takeshi Hayashi, Shinagawa-ku (JP); Hiroyuki Tsuchiya, Kyoto-city (JP); Xu Li, Osaka-city (JP); Toshikazu Nosaka, Izumi-city (JP)

Correspondence Address: BIRCH STEWART KOLASCH & BIRCH, PO BOX 747, FALLS CHURCH, VA, 22040-0747, US

(21) Appl. No.: 11/628,304

(22) PCT Filed: Jun. 4, 2004
(86) PCT No.: PCT/JP04/08181

§ 371 Date: Dec. 1, 2006

(30) Foreign Application Priority Data
Dec. 5, 2002 (JP) 2002-354438(P)

(51) Int. Cl. C01B 31/02; D01F 9/127

(52) U.S. Cl. 423/447.3; 422/198; 423/445 B; 423/445 R; 977/891

(57) ABSTRACT

Developed are a synthesizing method for carbon nanostructures where the generation of tar-like byproducts is reduced and carbon nanostructures are generated highly efficiently, and a unit therefor. A highly efficient material spraying type carbon nanostructure synthesizing apparatus according to the present invention is formed of a catalyst body that is placed inside a reaction tube, a heating unit that is provided in order to heat the vicinity of this catalyst body to the temperature range where carbon nanostructures are generated, a material gas supplying pipe for introducing a material gas into reaction tube which is provided in such a manner that an end of this supplying pipe is placed in proximity to catalyst body, and a preheating unit for preheating the material gas supplying pipe to a temperature range where no tar-like products are generated from a material gas. No tar-like substance is generated in the material gas supplying pipe, and the material gas is directly sprayed against the catalyst body, skipping the middle temperature range. Therefore, the probability of reaction occurring is high, and the yield in the generation of carbon nanostructures is high. Most of the material gas is consumed; thus, no tar-like substance is generated inside reaction tube.

### TECHNICAL FIELD

The present invention relates to a method for manufacturing carbon nanostructures from a material gas in accordance with a catalyst chemical vapor deposition method. More specifically, the present invention relates to a carbon nanostructure synthesizing method and apparatus where carbon nanostructures can be generated highly efficiently from a material gas, and tar-like byproducts that are generated from the material gas can be reduced.

### BACKGROUND ART

Carbon nanostructures have been attracting attention as a core substance used in nanotechnology. In the present invention, carbon nanostructures are a substance of a nano-size which is formed of carbon atoms, and examples thereof include carbon nanocoils in coil form, carbon nanotubes in tube form, carbon nano-twists which are carbon nanotubes having twists, carbon nanotubes with beads where beads are formed on carbon nanotubes, carbon nano-brushes where carbon nanotubes stand together in large numbers, and a fullerene in spherical shell form. In the following, carbon nanocoils and carbon nanotubes are illustrated from among these great number of carbon nanostructures, and the contents of the present invention are described.

Carbon nanocoils were synthesized for the first time in 1994 by Amelinckx et al. (Amelinckx, X. B. Zhang, D. Bernaerts, X. F. Zhang, V. Ivanov, and J. B. Nagy, SCIENCE, 265 (1994), 635). In addition, in 1999, Li et al. (W. Li, S. Xie, W. Liu, R. Zhao, Y. Zhang, W. Zhou, and G. Wang, J. Material Sci., 34 (1999) 2745) succeeded in generating carbon nanocoils using a catalyst where the external periphery of a graphite sheet is coated with iron grains. In both cases, however, the yield was low, and the method was not suitable for mass production.

Therefore, some of the present inventors developed the “Synthesizing Method of Carbon Nanocoils” described in Japanese Patent Laying-Open No. 2001-192204. This technique is the first example of a mass-production of carbon nanocoils being synthesized from a material gas such as hydrocarbon in accordance with a catalyst chemical vapor deposition (CCVD) method using an indium/tin/iron-based catalyst.

In addition, a conventional technique where this indium/tin/iron-based catalyst has been improved includes the “Synthesizing Method of Indium/Tin/Iron-Based Catalyst for Generating Carbon Nanocoils” described in Japanese Patent Laying-Open No. 2001-310130 by some of the present inventors. This technique shows a method for synthesizing an indium/tin/iron-based catalyst from a metal organic compound, and discloses a mass production method for an indium/tin/iron-based catalyst.

Carbon nanotubes are a carbon nanostructure that was discovered in 1991 by Sumio Iijima in a deposit on a cathode for carbon arc discharge. Since then, research has been conducted in order to develop methods for synthesizing a large amount of carbon nanotubes. Recently, “Synthesizing Method of Carbon Nanotubes” described in Japanese Patent Laying-Open Nos. 2002-180251 and 2002-180252 was published.

The former is a technique for synthesizing a large amount of carbon nanotubes on an active base where highly pure alumina of which the content of alkali metal is 0.05% or less contains a catalyst metal in accordance with a CVD method by making organic carbon material thermally decompose at a temperature of 400 to 500° C. In addition, the latter is a technique for synthesizing a large amount of carbon nanotubes on an active base that is formed by vapor depositing a catalyst metal at a rate of 0.001 to 0.005 mol/m² by making an organic carbon material thermally decompose at a temperature of 1100 to 1250° C.

As described above, conventionally, in the development of synthesizing methods, mainly, a catalyst for synthesizing a large amount of carbon nanostructures have been developed, while, at the same time, improving the synthesizing conditions, such as the temperature for synthesis. Recently, however, though synthesis in large amounts has been successful, there is a problem, such that wasteful byproducts are generated.

FIG. 19 is a schematic diagram showing the configuration in a case where a conventional carbon nanostructure synthesizing apparatus 40 is used for the generation of carbon nanocoils. As shown in Japanese Patent Laying-Open No. 2001-192204, carbon nanostructure synthesizing apparatus 40 is formed of a heater 6 for heating the reaction region placed around the outer periphery of a reaction tube 4, and the reaction temperature region, where the temperature is set so as to be uniform by means of this heater 6 for heating the reaction region is referred to as reaction region 10, and a catalyst body 12 is placed in this reaction region 10. A catalyst for generating carbon nanocoils made of indium/tin/iron is used for catalyst body 12.

He is used as a carrier gas, C₂H₂ is used as a material gas, and a mixed gas where He and C₂H₂ are mixed with an appropriate ratio of flow amount is made to flow in the direction arrow c. Reaction region 10 is set at 700° C., and the reaction time is set at one hour. As a result, C₂H₂ decomposes, and carbon nanostructures 14 made of carbon nanocoils grow on the surface of catalyst body 12.

It has been confirmed, however, that tar-like byproducts 16 adhere to the inner surface of reaction tube 4 in a scattered manner. Such tar-like byproducts have been analyzed and determined to be aromatic hydrocarbon. It has also been determined that the amount of alkyl base is very small, and that no paraffin-based hydrocarbon is contained. An infrared spectrum of tar-like byproducts 16 that is obtained in accordance with an FTIR method is analyzed so as to make speculations as to whether the byproducts are condensed aromatic ring substances, such as naphthalene or anthracene, CH₃ substituted substances of condensed aromatic ring substances, highly condensed aromatic ring substance combining substances, or a mixture of these multiple components.

It has been found that the locations where tar-like byproducts 16 adhere are on the inner surface of reaction tube 4, which is located before and after reaction region 10, and almost no tar-like byproducts exist on the inner surface of reaction region 10. Tar-like byproducts 16 are black and soil the reaction tube, making the task of cleaning troublesome. At the same time, a problem arises such that the products cannot be cleaned when adhering at locations that cannot be cleaned.

In addition, carbon nanocoils are generated with a density on a normal level, and it has been confirmed that the density at which carbon nanocoils grow decreases when the concentration of C₂H₂ is lowered. This is because a mixed gas is made to flow through the entire cross section of reaction tube 4, and therefore, C₂H₂ gas that flows in the direction of arrow e makes contact with catalyst body 12 so as to be converted to carbon nanocoils 14 through reaction, while C₂H₂ gas that flows at a distance from catalyst body 12 in the direction shown by arrow d passes without causing any reaction, so that a large amount of non-reacted material gas flows out to the downstream side.

Only the formation of tar-like byproducts 16 reduces the yield of carbon nanocoils, and in the case where C₂H₂ gas does not make contact with catalyst body 12, no reaction is caused, and these two factors are considered to be the cause of reduction in the yield.

FIG. 20 is a schematic diagram showing the configuration in a case where a conventional carbon nanostructure synthesizing apparatus 40 is used for the generation of carbon nanotubes. The configuration of carbon nanostructure synthesizing apparatus 40 is similar to that in FIG. 19, but is different in the following two points.

The first difference is that a catalyst where Ni is sintered to highly pure γ-alumina pellets (99.95% or more) of which the sodium content is 0.01% or less is used as catalyst body 12. The second difference is that a mixed gas of C₁₄ and Ar, which are mixed at an appropriate ratio of flow amount, is made to flow in the vicinity of the catalyst body in the direction of arrow c while being maintained at 500° C.

As a result, it has been found that carbon nanostructures 14 made of carbon nanotubes are generated with a normal density on the surface of catalyst body 12 made of pellets. In the same manner as in the conventional technique, however, it has been confirmed that tar-like byproducts 16 adhere to and blacken the inner surface of reaction tube 4 before and after reaction region 10. In addition, it has also been confirmed that the density of growth of carbon nanotubes does not increase beyond normal density. This is considered to be caused by the CH₄ that flows in the direction of arrow d not contributing to the reaction, and most of the CH₄ which is a material gas being used for the generation of tar-like byproducts 16.

As described above, it has been found that tar-like byproducts of which the amount cannot be ignored are formed on the inner surface of the reaction tube, and the yield in the generation of the carbon nanostructures does not sufficiently increase in conventional synthesizing apparatuses and in accordance with conventional synthesizing methods. Recently, it has been recognized that it is urgently required to solve these problems in order to generate highly pure carbon nanostructures with high density.

Accordingly, an object of the present invention is to provide a method and an apparatus for synthesizing carbon nanostructures where the reaction method and reaction apparatus are improved, and thereby, the amount of generated tar-like byproducts is reduced during the generation process of the carbon nanostructures, and in addition, the material gas efficiently reacts so as to significantly increase the yield in the generation of carbon nanostructures.

### DISCLOSURE OF THE INVENTION

The present invention is provided in order to solve the problems, and the first mode of the present invention provides a highly efficient material spraying type carbon nanostructure synthesizing method for synthesizing carbon nanostructures from a material gas in accordance with a catalyst chemical vapor deposition method, wherein a material gas of which the temperature is in a range where no tar-like byproducts are generated is sprayed so as to make contact with a catalyst body in a space that has been heated to within a temperature range for the generation of carbon nanostructures, so that carbon nanostructures are generated. It has been found, as a result of the research conducted by the present inventors, that tar-like byproducts are generated when the material gas decomposes and combines during the process where the temperature gradually increases from a low temperature to a temperature for the generation of carbon nanostructures. That is, the subject matter of the present invention is removal of the middle temperature range where the material gas decomposes and combines from the reaction process. Therefore, according to the present invention, the material gas is maintained within a temperature range (temperature that is lower than the middle temperature range; room temperature a temperature lower than that) where tar-like byproducts are not generated, and this material gas is introduced directly into the temperature range for the generation of carbon nanostructures, skipping the middle temperature, and thereby, it becomes possible to greatly reduce the generation of tar-like byproducts. In addition, the material gas is directly sprayed toward the reaction region, and therefore, the probability of reaction occurring between the catalyst body and the material gas within the reaction region increases, so that the yield in the generation of carbon nanostructures can be greatly increased. Furthermore, the catalyst body is fixed in the reaction region, and the material gas may be sprayed against this catalyst body, or the catalyst body may be supplied from a catalyst body tank or the like to the reaction region, if necessary.

The second mode of the present invention provides a highly efficient material spraying type carbon nanostructure synthesizing method for synthesizing carbon nanostructures from a material gas in accordance with a catalyst chemical vapor deposition method, wherein a material gas of which the temperature is preheated to within a range where no tar-like byproducts are generated is directly sprayed so as to make contact with a catalyst body in a space that has been heated to within a temperature range for the generation of carbon nanostructures, so that carbon nanostructures are generated. According to the present invention, the material gas is preheated to within a temperature range where no tar-like byproducts are generated, and the temperature of this material gas that is preheated is raised directly to the temperature for the generation of carbon nanostructures, skipping the middle temperature, and thereby, the generation of tar-like byproducts can be greatly reduced. This is different from the first invention in that the material gas is preheated. This preheating increases the reactivity of the material gas, and the probability of the material gas reacting in the catalyst region is greatly increased. In addition, the material gas is directly sprayed toward the reaction region, and therefore, the probability of the material gas reacting with the catalyst body in the reaction region increases, and the density in generation and the efficiency of generation of carbon nanostructures can be greatly increased. Furthermore, the catalyst body may be fixed in the reaction region so that the material gas is sprayed against this catalyst body, or the catalyst body may be supplied from a catalyst body tank or the like to the reaction region, if necessary.

The third mode of the present invention provides a highly efficient material spraying type carbon nanostructure synthesizing method wherein the catalyst body is formed of a catalyst structure. The catalyst body is formed of a catalyst structure, and thereby, it is possible to install a catalyst body only in the reaction region. Therefore, the catalyst body and the material gas can react with each other with high efficiency. Furthermore, carbon nanostructures are formed on the surface of the catalyst structure, and therefore, carbon nanostructures can be collected from this catalyst structure with high efficiency.

The fourth mode of the present invention provides a material spraying type carbon nanostructure synthesizing method wherein the catalyst structure has at least one or more structures from among a structure in plate form, a structure in layered form, a structure in grate form, a porous structure and a structure in fiber form. According to the present invention, the structure of the catalyst structure can be selected in accordance with the type of the catalyst structure for carbon nanostructures to be synthesized. Carbon nanostructures can be generated with high efficiency by using a catalyst structure having a structure in layered form, a structure in grate form, a porous structure or a structure in fiber form having a large surface area. Furthermore, a catalyst structure having a structure in plate form is used, and thereby, carbon nanostructures can be easily collected.

The fifth mode of the present invention provides a highly efficient material spraying type carbon nanostructure synthesizing method wherein the catalyst body is formed of a catalyst powder. The catalyst body is formed of a catalyst powder, and thereby, the catalyst body can be easily supplied when necessary. Furthermore, carbon nanostructures that have been formed on the surface of grains that form the catalyst powder can be easily collected by making the catalyst powder flow out.

The sixth mode of the present invention provides a highly efficient material spraying type carbon nanostructure synthesizing method wherein the catalyst powder is supplied to a reaction region in the space that has been heated to within the temperature range for the generation of carbon nanostructures and, then, is heated to within the temperature range for the generation of carbon nanostructures. According to the present invention, the catalyst powder can be supplied to the reaction region when necessary, and the material gas and the catalyst powder can react with each other with high efficiency.

The seventh mode of the present invention provides a highly efficient material spraying type carbon nanostructure synthesizing method wherein the catalyst powder is supplied from a catalyst powder supplying pipe into the space that has been heated to within the temperature range for the generation of carbon nanostructures. The catalyst powder is supplied from the catalyst powder supplying pipe, and thereby, a necessary and appropriate amount can be supplied to the reaction region. Furthermore, the catalyst powder supplying pipe is heated, and thereby, a catalyst powder that has been heated to within the temperature range for the generation of carbon nanostructures can be supplied, so as to immediately react with the material gas.

The eighth mode of the present invention provides a highly efficient material spraying type carbon nanostructure synthesizing method wherein a material gas into which the catalyst powder is mixed is sprayed into the space that has been heated to within the temperature range for the generation of carbon nanostructures. The mixture ratio for the material gas to the catalyst powder can be adjusted to an appropriate amount, and thereby, carbon nanostructures can be synthesized with high efficiency. Furthermore, the mixed gas is heated so that the material gas and the catalyst powder are preheated to the same temperature, and thus, the mixed gas is instantly heated to within the temperature range for the generation of carbon nanostructures when introduced into the reaction region, and carbon nanostructures can be synthesized with high efficiency.

The ninth mode of the present invention provides a highly efficient material spraying type carbon nanostructure synthesizing method wherein the material gas is sprayed against a catalyst powder inside the space that has been heated to within the temperature range for the generation of carbon nanostructures while this catalyst powder is being stirred. The catalyst powder is stirred so that the material gas and the catalyst powder efficiently make contact with each other, and carbon nanostructures can be synthesized with high efficiency. As for the method for stirring, a vibration method using ultrasonic vibration or the like, a rotation method for rotating a rotational plate or a container to which the catalyst powder is supplied, a fluctuation method for making a fluctuation plate that is provided within the reaction region fluctuate, or other known methods can be used.

The tenth mode of the present invention provides a synthesizing method of carbon nanostructures wherein the temperature of the preheated material gas is set at 300° C. or less. For example, the temperature at which tar-like byproducts are generated from hydrocarbon that is used as the material gas is 300° C. to 600° C., and the temperature at which carbon nanostructures are generated from hydrocarbon slightly varies depending on the type of catalyst, but is 550° C. or more, and it is assumed that the temperature where carbon nanostructures are efficiently generated is 600° C. to 1200° C. Accordingly, when the temperature of the preheated material gas is controlled so as to be 300° C. or less, and this preheated material gas is directly fed into the reaction region at 600° C. or more, the material gas does not pass through the region in which the temperature is that for the generation of tar-like byproducts, and therefore, theoretically, tar-like byproducts are not generated.

The eleventh mode of the present invention provides a highly efficient material spraying type carbon nanostructure synthesizing apparatus for synthesizing carbon nanostructures from a material gas in accordance with a catalyst chemical vapor deposition method, wherein a heating unit for heating a reaction region to within a temperature range for the generation of carbon nanostructures is provided, and a material gas supplying pipe for introducing a material gas into the reaction region is provided in such a manner that a material gas spraying nozzle thereof is placed within the reaction region, so that a material gas that is in a temperature range where no tar-like byproducts are generated is sprayed from the material gas spraying nozzle against a catalyst body. The temperature of the material gas is within a temperature range where no tar-like byproducts are generated, and therefore, no tar-like byproducts are generated inside the material gas supplying pipe. In addition, this material gas is directly sprayed from the material gas spraying nozzle against a catalyst body in the structure, and therefore, there is a high possibility that the material gas will make contact with the catalyst so as to be efficiently converted to carbon nanostructures, and the generation of tar-like byproducts can be significantly reduced. Most of the material gas is consumed through the catalyst reaction, and therefore, the generation of tar-like substances in the reaction tube can be greatly reduced.

The twelfth mode of the present invention provides a highly efficient material spraying type carbon nanostructure synthesizing apparatus for synthesizing carbon nanostructures from a material gas in accordance with a catalyst chemical vapor deposition method, wherein a heating unit for heating a reaction region to within a temperature range for the generation of carbon nanostructures is provided, a material gas supplying pipe for introducing a material gas into the reaction region is provided in such a manner that a material gas spraying nozzle thereof is placed within the reaction region, and a preheating unit for preheating the material gas supplying pipe to within a temperature range where no tar-like products are generated from the material gas is formed so that a preheated material gas is sprayed from the material gas spraying nozzle against a catalyst body. No tar-like products are generated inside the material gas supplying pipe within the temperature range for preheating. In addition, a preheated material gas is directly sprayed from the material gas spraying nozzle to the catalyst body in the structure, and therefore, there is a high probability that the preheated material gas will make contact with the catalyst, so that carbon nanostructures can be synthesized with high efficiency. Accordingly, in the same manner as in the aforementioned unit, most of the material gas is consumed through the catalyst reaction, and therefore, the generation of tar-like substances in the reaction tube can be prevented.

The thirteenth mode of the present invention provides a highly efficient material spraying type carbon nanostructure synthesizing apparatus for synthesizing carbon nanostructures from a material gas in accordance with a catalyst chemical vapor deposition method, wherein a heating unit for heating a reaction region to within a temperature range for the generation of carbon nanostructures is provided, a mixed gas supplying pipe for introducing a mixed gas of a material gas and a catalyst body into the reaction region is provided in such a manner that a mixed gas spraying nozzle thereof is placed within the reaction region, and a preheating unit for preheating the mixed gas supplying pipe to within a temperature range where no tar-like products are generated from the mixed gas is provided so that a preheated mixed gas is sprayed into the reaction region. No tar-like products are generated inside the mixed gas supplying pipe within the temperature range for preheating. The mixed gas that has been sprayed from the mixed gas spraying nozzle into the reaction region is instantly heated to the temperature for the generation of carbon nanostructures, and the material gas and the catalyst body in the mixed gas efficiently make contact with each other through spraying, and therefore, carbon nanostructures can be generated with high efficiency. Accordingly, most of the material gas is consumed through the catalyst reaction, and therefore, the generation of tar-like substances in the reaction tube can be prevented.

The fourteenth mode of the present invention provides a highly efficient material spraying type carbon nanostructure synthesizing apparatus wherein a catalyst body supplying pipe for supplying a catalyst body to the reaction region is placed, and a preheating unit for preheating this catalyst body supplying pipe is provided, so that the material gas is sprayed against a preheated catalyst body. A catalyst body can be passed through the catalyst supplying pipe for supplying the catalyst body, and can be supplied to the reaction region, and thereby, a required amount of a catalyst powder can be supplied. Furthermore, the catalyst body is preheated using the preheating unit, and thereby, the temperature of the catalyst body that has been supplied to the reaction region instantly reaches the temperature for the generation of carbon nanostructures so as to react with the material powder.

The fifteenth mode of the present invention provides a highly efficient material spraying type carbon nanostructure synthesizing apparatus wherein a stirring unit for stirring a catalyst body in the reaction region is provided, and a material gas is sprayed against a catalyst body while the catalyst body is being stirred. The catalyst powder is stirred, and thereby, the material gas can be made to efficiently make contact with the catalyst powder, so that carbon nanostructures can be synthesized with high efficiency. The stirring unit may be formed of vibration means using ultrasonic vibration or the like, rotation means for rotating a rotational plate or a container to which a catalyst powder is supplied, fluctuation means for causing a fluctuation movement in a fluctuation plate that has been provided within the reaction region, or any other known means. Furthermore, a predetermined amount of catalyst body may be deposited in the reaction region, and after that, the catalyst body may be stirred, or the catalyst body may be stirred while being supplied.

The sixteenth mode of the present invention provides a highly efficient material spraying type carbon nanostructure synthesizing method wherein the catalyst body is a catalyst for the synthesis of carbon nanocoils. In the case where a catalyst for the synthesis of carbon nanocoils is used, carbon nanocoils can be selectively generated from hydrocarbon, and therefore, according to the method of the present invention, the amount of tar-like byproducts can be reduced, and at the same time, carbon nanocoils can be synthesized with high density and high efficiency. As the catalyst for the synthesis of carbon nanocoils, a metal carbide catalyst, a metal oxide catalyst or a metal-based catalyst containing a transition metal element can be used. Transition metal element refers to a transition element as that shown in the periodic table of elements, and concretely, is any of Sc to Cu in the fourth period, Y to Ag in the fifth period, or La to Au in the sixth period. When an element that has been selected from the transition metal elements is referred to as A, as the metal carbide, AInC, ASnC, AInSnC and the like can be used as the catalyst for the synthesis of carbon nanostructures. Furthermore, as the metal oxide, AInO, ASnO, AInSnO, AAlSnO and ACrSnO can be used as the catalyst for the synthesis of carbon nanostructures, and as the metal-based catalyst, AAlSn, ACrSn and AInSn can be used. Furthermore, as an appropriate metal catalyst, a metal catalyst that contains an Fe element in a transition metal element can be used as the catalyst for the synthesis of carbon nanostructures. Concretely, an Fe-based metal carbide catalyst such as FeₓIn_{y}C_{z}, FeₓSn_{y}C_{z} and FeₓIn_{y}C_{z}Sn_{w} can be used as the catalyst for the synthesis of carbon nanostructures, and a preferable composition ratio for the metal carbide catalyst is Fe₃InC_{0.5}, Fe₃SnC or Fe₃In₁₋ᵥC_{0.5}Sn_{w} (0≦v<1, w≧0). Furthermore, as the catalyst for the synthesis of carbon nanostructures, an Fe-based metal catalyst, such as FeₓIn_{y}Sn_{z}, FeₓAl_{y}Sn_{z} or FeₓCr_{y}Sn_{z} can be used, and a preferable composition ratio is Fe₃In_{y}Sn_{z} (y≦9, z≦3), FeₓAl_{y}Sn_{z} (y≦1, z≦3) or FeCr_{y}Sn_{z} (y≦1, z≦3). A catalyst body is selected from among these metal catalysts on the basis of the purpose, and thereby, carbon nanostructures can be generated with high efficiency.

The seventeenth mode of the present invention provides a highly efficient material spraying type carbon nanostructure synthesizing method wherein the material gas includes at least one of acetylene, allylene, ethylene, benzene or toluene, and alcohol or methane. This material gas from among hydrocarbon material gases is appropriate particularly in the case where carbon nanostructures are generated, which allows for mass production of carbon nanostructures without generating tar-like byproducts.

The eighteenth mode of the present invention provides a highly efficient material spraying type carbon nanostructure synthesizing method wherein the carbon nanostructures are carbon nanocoils, carbon nanotubes, carbon nano-twists, carbon nanotubes with beads, carbon nano-brushes or fullerene. Specific carbon nanostructures can be selectively mass produced by changing the type of catalyst body, or by adjusting the temperature for the generation of carbon nanostructures in the reaction region so that it varies.

### BRIEF DESCRIPTION OF THE DRAWINGS

FIG. 1 is a schematic diagram showing the configuration in the case where a highly efficient material spraying type carbon nanostructure synthesizing apparatus 2 according to the present invention is used for the synthesis of carbon nanocoils.

FIG. 2 is a diagram showing the entire configuration in the case where attached units are combined with highly efficient material spraying type carbon nanostructure synthesizing apparatus 2 shown in FIG. 1.

FIG. 3 is an electron microscope image of carbon nanocoils, having been magnified 10000 times, which have been obtained under Condition 1 (½ of standard concentration).

FIG. 4 is an electron microscope image of carbon nanocoils, having been magnified 5000 times, which have been obtained under Condition 1 (½ of standard concentration).

FIG. 5 is an electron microscope image of carbon nanocoils, having been magnified 10000 times, which have been obtained under Condition 2 (¼ of standard concentration).

FIG. 6 is an electron microscope image of carbon nanocoils, having been magnified 5000 times, which have been obtained under Condition 2 (¼ of standard concentration).

FIG. 7 is an electron microscope image of carbon nanocoils, having been magnified 10000 times, which have been obtained under Condition 3 (⅛ of standard concentration).

FIG. 8 is an electron microscope image of carbon nanocoils, having been magnified 30000 times, which have been obtained under Condition 3 (⅛ of standard concentration).

FIG. 9 is an electron microscope image of carbon nanocoils, having been magnified 10000 times, which have been obtained under Condition 4 (same as the standard concentration).

FIG. 10 is an electron microscope image of carbon nanocoils, having been magnified 5000 times, which have been obtained under Condition 4 (same as the standard concentration).

FIG. 11 is an electron microscope image of carbon nanocoils, having been magnified 10000 times, which have been obtained under Condition 5 (⅔ of standard concentration).

FIG. 12 is an electron microscope image of carbon nanocoils, having been magnified 10000 times, which have been obtained under Condition 6 (⅓ of standard concentration).

FIG. 13 is a schematic diagram showing the configuration in the case where highly efficient material spraying type carbon nanostructure synthesizing apparatus 2 according to the present invention is used for the synthesis of carbon nanotubes.

FIG. 14 is a schematic diagram showing the configuration in the case where a catalyst powder is used as the catalyst body of the highly efficient material spraying type carbon nanostructure synthesizing apparatus according to the present invention.

FIG. 15 is a schematic diagram showing the configuration in the case where a catalyst powder supplying pipe is provided to the highly efficient material spraying type carbon nanostructure synthesizing apparatus according to the present invention.

FIG. 16 is a schematic diagram showing the configuration in the case where a mixed gas supplying pipe is provided to the highly efficient material spraying type carbon nanostructure synthesizing apparatus according to the present invention.

FIG. 17 is a schematic diagram showing the configuration in the case where a stirring apparatus 17 is provided to highly efficient material spraying type carbon nanostructure synthesizing apparatus 2 according to the present invention.

FIG. 18 is a schematic diagram showing the configuration of each gas supplying pipe 8 and its gas spraying nozzle according to the present invention.

FIG. 19 is a schematic diagram showing the configuration in the case where a conventional carbon nanostructure synthesizing apparatus 40 is used for the generation of carbon nanocoils.

FIG. 20 is a schematic diagram showing the configuration in the case where conventional carbon nanostructure synthesizing apparatus 40 is used for the generation of carbon nanotubes.

### BEST MODES FOR CARRYING OUT THE INVENTION

The present inventors have diligently researched the mechanism for generating a tar-like substance which is a byproduct at the time of the synthesis of carbon nanostructures, and as a result, have discovered that the material gas molecules decompose in a specific temperature range and the products of decomposition associate with each other so as to form aromatic rings, and these aromatic rings condense so as to form gigantic molecules that become tar.

When an infrared absorbing spectrum was measured on the tar-like byproducts in accordance with an FTIR method, a great number of absorption peaks appeared, and then, attribution determination of molecular vibrations was carried out on the respective absorption wave number. The results are as follows.

<Attribution Determination of Absorption>

| <Absorption wave number (cm⁻¹)> | <Attribution of vibration> |
|---|---|
| 3047 | CH expanding and contracting |
| | vibration of aromatic nucleus |
| 2920 | CH expanding and contracting |
| | vibration of aliphatic |
| 1597 | C═C expanding and contracting |
| | vibration of aromatic nucleus |
| 1504 | C═C expanding and contracting |
| | vibration of aromatic nucleus |
| 1450 | C═C expanding and contracting |
| | vibration of aromatic nucleus |
| 1389 | Bending vibration of CH₃ |
| 957 | Out of plane bending vibration |
| | of CH of aromatic nucleus |

From the aforementioned results, the tar-like substance can be concluded to be an aromatic hydrocarbon. It is considered that the peak where the wave number is 2920 (cm⁻¹) comes from an alkyl base and the absorption intensity thereof is considerably small in comparison with the other absorption intensities, and therefore, it is determined that the amount of the alkyl base is very small and almost no paraffin-based hydrocarbon is contained.

It is determined from the infrared spectrum that the tar-like substance is any of naphthalene with two benzene rings, anthracene with three benzene rings, condensation aromatic ring substances where a large number of benzene rings are condensed, and CH₃ substitution substances of these condensation aromatic rings. A search and examination were carried out on the standard charts, failing in discovering an identifiable chart. Accordingly, it can be determined that this is a certain type of tar pitch.

In addition, mass analysis was carried out on the tar-like substance. The used mass analyzer was of a type that could measure substances of which the molecular weight was 1000 or less. A mass spectrum of molecular weight, 1000 or less, could not be observed using this mass analyzer. This means that the tar-like substance is formed of gigantic molecules of which the molecular weight is 1000 or more.

It is determined from the two spectra, infrared spectrum and mass spectrum, that these gigantic molecules are a condensation aromatic ring substance where a great number of C₆H₆ are condensed. The process where such a condensation aromatic ring substance is formed from C₂H₂, which is a material gas, is estimated to be a two-stage reaction that is made of an association reaction of (1) and a polymerization reaction of (2).
3C₂H₂→C₆H₆ (1)
nC₆H₆→(C₆H₆)ₙ (2)

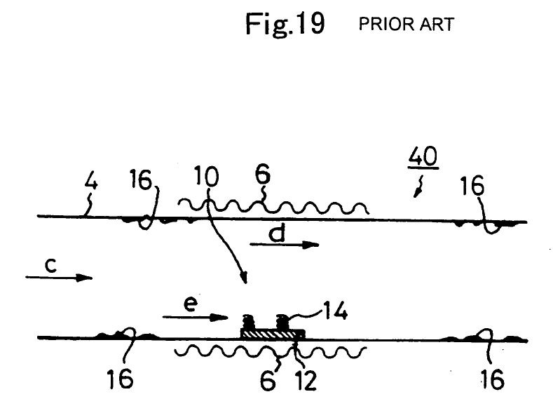

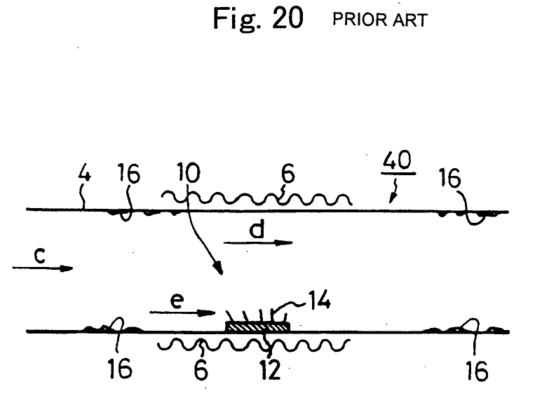

Next, the temperature range where this polymerization reaction occurs was examined. The catalyst was removed from the reaction region of FIGS. 19 and 20, and the amount of the tar-like substance attached to the inner surface of the reaction tube was examined while varying the temperature in the reaction region. As a result, it was found that this polymerization reaction occurs in a range from 300° C. to 600° C.

The discovery of this polymerization temperature range leads to an extremely important conclusion. That is, no polymerization reaction occurs in the temperature range of 300° C. or less and in the temperature range of 600° C. or less, and therefore, it is concluded that no tar-like substance is generated in the case where C₂H₂ is used.

As a result of the research conducted by the present inventors, it has been found that the temperature range, where carbon nanocoils are generated when an indium/tin/iron-based catalyst is used and the material gas is C₂H₂, is 550° C. or more and desirable from 600° C. to 1200° C. That is, at a temperature of 550° C. or more, the following decomposing reaction of C₂H₂ occurs.
C₂H₂→2C+H₂

Accordingly, in order to generate carbon nanocoils without generating a tar-like substance from C₂H₂, it becomes necessary to make the temperature of C₂H₂ jump from a temperature of 300° C. or less to a temperature in the area of 600° C. without passing through the middle temperature region of 300° C. to 600° C. In other words, the temperature of the C₂H₂ gas is set at a temperature in a range from a low temperature (room temperature) to 300° C., and this material gas is instantly sprayed into the catalyst region of which the temperature has been set to 600° C. or more, and thereby, it becomes possible to exclude the generation of the tar-like substance.

In order to set the temperature of the C₂H₂ gas at a temperature in a range from a low temperature (room temperature) to 300° C., there are two methods, one being a case where a material gas at a low temperature or room temperature outside the reactor is introduced into the catalyst region without change, and the other being a case where this material gas is preheated to a temperature of 300° C. or less and this preheated material gas is introduced into the catalyst region. As for this preheating system, it includes a system of preheating outside the reaction tube and a system of preheating in the reaction tube. Either one of these systems is included in the method of the present invention.

When the type of catalyst is changed, carbon nanostructures other than carbon nanocoils can be generated, and the temperature range where the tar-like substance is generated slightly fluctuates depending on the type of the catalyst. In addition, it has been found that the temperature range where carbon nanostructures are generated slightly fluctuates depending on the type of the catalyst.

In Japanese Patent Laying-Open No. 2002-180251, for example, carbon nanotubes are selectively generated at a temperature of 400° C. or more when the material gas is CH₄ and a highly pure alumina pellet catalyst, that contains an Ni metal where the content of alkali metals is controlled to be 0.05% or less, is used. In addition, according to the experiments performed by the present inventors, the temperature range where the tar-like substance is generated with this catalyst was from 250° C. to 400° C.

Accordingly, in the case where this highly pure alumina pellet catalyst that contains an Ni metal is used, targeted carbon nanotubes can be generated without generating the tar-like substance when the temperature of the material gas such as CH₄ is set at 250° C. or less, and this material gas is instantly sprayed against the catalyst body of which the temperature is 400° C. or more.

Furthermore, there are concrete systems, a system where a material gas that has been cooled to a low temperature is directly sprayed against the catalyst body, a system where a material gas at room temperature is directly sprayed against the catalyst body, and a system where a material gas at a low temperature or room temperature is preheated to a temperature of 250° C. or less, and this preheated gas is sprayed against the catalyst body. A variety of modified patterns can be designed for the preheating system in such a manner that the material gas at room temperature may be preheated to a temperature of 250° C. or less outside the reaction tube, or may be preheated to a temperature of 250° C. or less inside the reaction tube. In any case, it is important to maintain the temperature of the material gas in a range where no tar-like substance is generated, and an essential point of the invention is to directly spray this material gas against the catalyst body.

In the case where the material gas or the catalyst is changed, the temperature range where the tar-like substance is generated slightly changes but still is a relatively low temperature range. In addition, the temperature range where carbon nanostructures are selectively generated is a relatively high temperature range which does not overlap much the temperature range where the tar-like substance is generated. Accordingly, the temperature of the material gas is maintained in a temperature range where no tar-like substance is generated, and this material gas is instantly sprayed against the catalyst body of which the temperature is in a temperature range where carbon nanostructures are generated, and thereby, it becomes possible to selectively generate the carbon nanostructures while greatly reducing the generation of tar-like byproducts.

According to the aforementioned method, no tar-like substance is generated as a byproduct, and therefore, reflective effects can be obtained where the density of the generation and the yield in the generation of carbon nanostructures are increased relatively. In order to further increase the yield in the generation of carbon nanostructures, the following means are carried out in the present invention.

In a conventional synthesizing apparatus of carbon nanostructures, the reaction tube through which a material gas flows is formed in such a manner that the cross sectional area of the reaction tube is much greater than the cross sectional area of the catalyst that is placed in this direction. The flowing material gas makes contact with the surface of the catalyst so that a catalyst reaction occurs, whereas, a material gas that passes through at a distance from the catalyst merely passes through causing almost no reaction.

In such a reaction tube having a large cross sectional area, a mixed gas of a carrier gas and a material gas, which flows through the inside, is made to flow at a low speed in order to increase the probability of contact with the catalyst body. At a low speed, it seems that the mixed gas is in a state of flowing in layers where He, which is the carrier gas, and the C₂H₂, which is the material gas, are not uniformly mixed with each other, and the concentration of the material gas is somewhat uneven within the reaction tube, and the temperature of the mixed gas is also somewhat uneven.

Therefore, according to the present invention, a method is adopted where the aforementioned material gas is sprayed against the surface of the catalyst in a concentrated form or is sprayed into the reaction area, and thereby, the probability of contact between the material gas and the surface of the catalyst is significantly increased, and thus, the probability of the generation of carbon nanostructures is increased.

In order to implement a method for spraying a material gas (material gas at room temperature or preheated material gas) against the surface of the catalyst in a concentrated form in a unit of the present invention, a material gas supplying pipe for introducing a material gas into the reaction tube is placed separately from the reaction tube, and the material gas spraying nozzle of the supplying pipe is provided in the vicinity of the surface of the catalyst body. That is, the material gas or the mixed gas of the material gas and the carrier gas is introduced into the reaction tube having a large diameter through the pipe having a small diameter.

In such a configuration of the apparatus, the material gas is forcefully made to make contact with the surface of the catalyst body in a concentrated form, and the probability of the generation of carbon nanostructures is significantly increased. At the same time, even in the case where the concentration of the material gas that flows through the material gas supplying pipe is set lower than that according to the conventional technique, the yield in the generation of carbon nanostructures can be maintained the same or increased than that of the conventional technique due to an increase in the probability of the generation.

In addition, the cross sectional area of the material gas supplying pipe is relatively small, and therefore, when the material gas or the mixed gas of the material gas and the carrier gas is sprayed from the material gas spraying nozzle, it seems that there is unevenness in the temperature or the concentration in this cross section. In this sense, the material gas makes contact with the catalyst body while maintaining uniform temperature and uniform concentration, and thus, carbon nanostructures can grow relatively uniformly on the surface of the catalyst body.

As for the material gas that is used in the present invention, sulfur containing organic gases such as thiophene, phosphorous containing organic gases, hydrocarbon gases and the like can be utilized, and from among these, hydrocarbon is preferable because no unnecessary elements are added. As for the hydrocarbon, alkane compounds such as methane and ethane, alkene compounds such as ethylene and butadiene, alkyne compounds such as acetylene, aryl hydrocarbon compounds such as benzene, toluene and styrene, aromatic hydrocarbon having a condensed ring such as indene, naphthalene and phenanthrene, cycloparaffin compounds such as cyclopropane and cyclohexane, cycloolefin compounds such as cyclopentene, alicyclic hydrocarbon compounds having a condensed ring such as steroid and the like can be used. In addition, it is possible to use a mixed hydrocarbon gas where two types or more from among the hydrocarbon compounds are mixed. In particular, low molecular hydrocarbon is desirable and acetylene, allylene, ethylene, benzene and toluene, for example, are preferable.

The carrier gas that is used in the present invention is a gas which can convey the material gas, and He, Ne, Ar, N₂ and H₂, for example, can be used. The gas that is made to flow through the material gas supplying pipe may only be a material gas or a mixed gas of a material gas and the aforementioned carrier gas. In addition, though it is preferable for the gas that is made to flow through the reaction tube, excluding the material gas supplying pipe, to be a carrier gas, a gas in which a material gas is mixed with a carrier gas may be partially used.

In the case where the gas that is made to flow through the material gas supplying pipe is a mixed gas of a material gas and a carrier gas, the concentration ratio in the mixed gas can be freely determined by taking the amount of generated carbon nanostructures into account. Even when the concentration of the material gas is lower than that in a conventional apparatus which does not have a material gas supplying pipe, the probability of a reaction is increased due to a material gas spraying system, and therefore, the yield in the generation of carbon nanostructures can be secured at a level higher than that of the conventional technique.

The material gas is directly sprayed against the catalyst body that has been heated to 600° C. to 1200° C. in the reaction tube, and therefore, the material gas spraying nozzle of the material gas supplying pipe is placed in the vicinity of the catalyst body, and placed in the configuration in such a manner that the material gas is directly sprayed against the surface of the catalyst body. One or more material gas supplying pipe may be used where the material gas spraying nozzle is formed so as to have an opening of a round hole, a rectangular hole or the like from among a variety of forms, and it is desirable for the material gas spraying nozzle to be formed so as to make the material gas make contact with a large contact area on the surface of the catalyst body.

The temperature of the material gas that is sprayed from the material gas supplying pipe is set within a range where no tar-like substance is generated. This temperature ranges from a low temperature (room temperature) to the lowest temperature where the tar-like substance is generated. Accordingly, it is not necessary to heat the material gas when the material gas at a low temperature or room temperature is sprayed. In order to enhance the reactivity of the material gas, it is desirable to preheat the material gas to a temperature that is not higher than the lowest temperature where the tar-like substance is generated.

There are two methods in the system of preheating the material gas. A first method is a case where the material gas is preheated outside of the reaction tube, and this preheated gas is introduced into the material gas supplying pipe in the reaction tube. A second method is a case where the material gas at a low temperature or room temperature is introduced into the material gas supplying pipe, and the material gas supplying pipe is heated so that the material gas inside is heated.

In the former case, that is, in a case where the material gas that has been heated outside is introduced into the material gas supplying pipe, it is not necessary to provide a heater for heating the supplying pipe around the material gas supplying pipe. That is, this case is included in a case where the temperature of the material gas that is introduced into the material gas supplying pipe ranges from a low temperature (room temperature) to the lowest temperature where the tar-like substance is generated.

In the latter case, that is, in a case where the material gas supplying pipe is heated, a heater for heating the supplying pipe is provided around the material gas supplying pipe. The material gas is preheated by this heater for heating the supplying pipe in the temperature region where no tar-like substance is generated. This preheated temperature more or less depends on the type of the material gas and may be set at a temperature of 300° C. or less for C₂H₂. In order to enhance the reactivity with the catalyst, it is desirable for the temperature to be set at the highest temperature, which is approximately 300° C.

According to the present invention, most of the material gas is converted to carbon nanostructures on the surface of the catalyst body, and an extremely small amount of the material gas flows downstream without being involved in the reaction. Therefore, effects are obtained where the amount of the tar-like products that are generated in a downstream area of the reaction tube can be significantly reduced. That is, according to the present invention, almost no tar-like substance is generated in this phenomenon, and therefore, almost no tar-like byproducts are attached to the reaction tube on the upstream side or on the downstream side of the reaction region.

### EXAMPLE 1

### Generation of Carbon Nanocoils

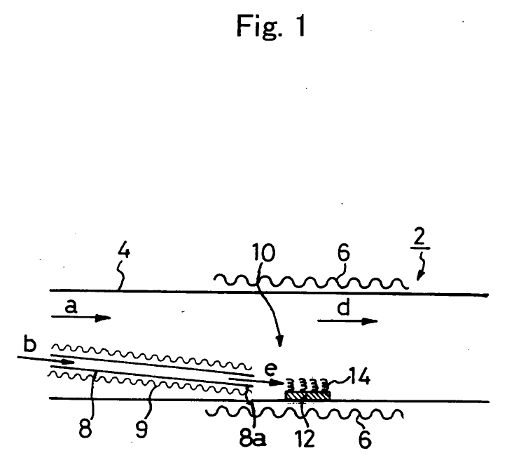

FIG. 1 is a schematic diagram showing the configuration of a case where a highly efficient material spraying type carbon nanostructure synthesizing apparatus according to the present invention is used for the synthesis of carbon nanocoils. In a highly efficient material spraying type carbon nanostructure synthesizing apparatus 2, a heater 6 for heating a reaction region is placed around the outside of a reaction tube 4, and this heater 6 for heating the reaction region provides a uniform reaction temperature region as a reaction region 10. A catalyst body 12 is placed in this reaction region 10.

In addition, a material gas supplying pipe 8, having a small diameter, is placed in reaction tube 4, and an end 8a of this supplying pipe reaches the middle of reaction region 10, and in addition, end 8a of the supplying pipe is placed in the vicinity of catalyst body 12. A heater 9 for heating the supplying pipe is placed around the material gas supplying pipe 8 and heats the entirety of material gas supplying pipe 8 to a temperature in the range where no tar-like substance is generated, and this temperature is maintained. In Examples 1 to 6, material gas supplying tube 8 in a nozzle form is used.

Reaction tube 4 is a crystal tube of which the cross section has a diameter (outer diameter) of 33 mm (inner diameter of 28 mm), and a pipe made of SUS having an outer diameter of 3.2 mm and an inner diameter of 1.6 mm is used as material gas supplying pipe 8. Catalyst body 12 is made of a substrate of crystal glass on which an indium/tin/iron-based catalyst is formed. A manufacturing method of the indium/tin/iron-based catalyst is described in the following.

First, 8.1 g of indium octylate (made by Daiken Chemical Co., Ltd.) and 0.7 g of tin octylate (made by Daiken Chemical Co., Ltd.) are mixed in toluene and are dissolved uniformly by means of ultrasonic vibration. This organic solution is applied with a brush to a crystal glass substrate which is a square having sides of 10 mm, and this is dried with hot air so that an organic film is formed.

This crystal glass substrate was placed in a heating furnace at 500° C. for 20 minutes so as to thermally decompose the organic components, and thereby, an indium/tin film was formed. The thickness of this indium/tin film was 300 nm. An iron film having a thickness of 20 nm was formed on the indium/tin film on this glass substrate in accordance with a vacuum vapor deposition method, and thus, an indium/tin/iron-based catalyst was formed.

Highly pure He (purity: 99.999 vol %), manufactured by Taiyo Toyo Sanso Co., Ltd. was used as the carrier gas, and acetylene for general fusion (purity: 98 vol % or more), manufactured by Saangas Nichigo Co., Ltd. was used as C₂H₂. The pressure of the carrier He was 1 atm, the flow rate was 0.8 cm/s, the temperature of the reaction region was 700° C. and the reaction time was 30 minutes. These conditions are the same for the following three types of examples.

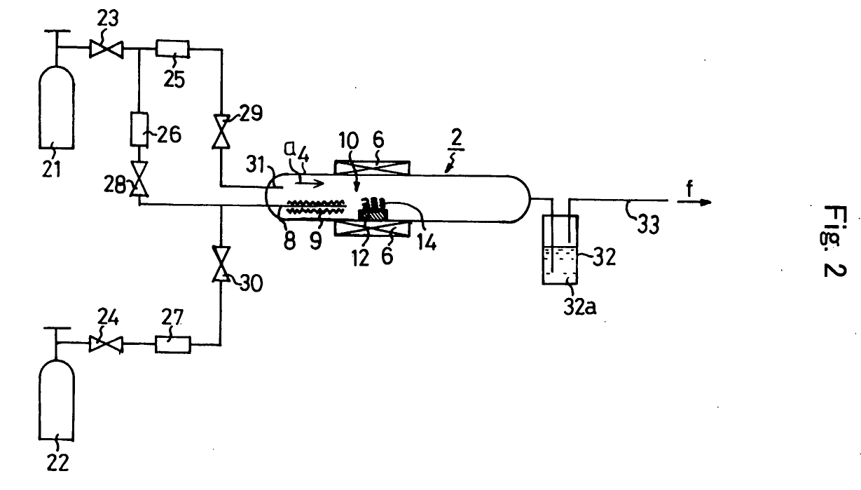

FIG. 2 is a diagram showing the entire configuration of a case where attached units are combined with the carbon nanostructure synthesizing apparatus shown in FIG. 1. He is supplied from a carrier gas container 21 via a valve 23, and the amount of flow is controlled by a mass flow controller 25 so that He is supplied to a carrier gas supplying pipe 31 via a valve 29.

In addition, He, of which the amount of flow is controlled by a mass flow controller 26, is also supplied to material gas supplying pipe 8 via a valve 28. Meanwhile, C₂H₂ is supplied from a material gas container 22 via a valve 24. The amount of flow of this C₂H₂ is controlled by a mass flow controller 27 so as to be supplied to material gas supplying pipe 8 via a valve 30. Accordingly, a mixed gas of He and C₂H₂ is supplied to material gas supplying pipe 8.

Furthermore, after making carbon nanostructures, which are carbon nanocoils, grow on catalyst body 12, the passing gas flows to a tar trap 32 where a cooling material 32a that has been cooled to an ice temperature is internally provided. The tar-like byproducts that have been cooled are trapped in this tar trap 32 while the remaining gas flows out from an exhaust pipe 33 in the direction of arrow f.

As described above, He flows through reaction tube 4 in the direction of arrow a, and a mixed gas of He and C₂H₂ flows through material gas supplying pipe 8. The respective concentration conditions were three types of Condition 1, Condition 2 and Condition 3.

In Condition 1, a mixed gas of He=100 (SCCM) and C₂H₂=30 (SCCM) flows through material gas supplying pipe 8, and He=130 (SCCM) flows through reaction tube 4. The concentration ratio of C₂H₂ to the entirety is 30/260×100=11.5 (vol %). The concentration ratio of C₂H₂ in the conventional synthesizing apparatus which does not have material gas supplying pipe 8 is 23 (vol %), and the concentration of C₂H₂ is set at ½ of the reference concentration in Condition 1 when the 23 (vol %) is referred to as the reference concentration.

In Condition 2, a mixed gas of He=50 (SCCM) and C₂H₂=15 (SCCM) flows through material gas supplying pipe 8, and He=195 (SCCM) flows through reaction tube 4. The concentration ratio of C₂H₂ to the entirety is 15/260×100=5.8 (vol %), which has been set at ¼ of the reference concentration.

In Condition 3, a mixed gas of He=25 (SCCM) and C₂H₂=8 (SCCM) flows through material gas supplying pipe 8, and He=227 (SCCM) flows through reaction tube 4. The concentration ratio of C₂H₂ to the entirety is 8/260×100=3.1 (vol %), which has been set at ⅛ of the reference concentration.

A state of the generation of carbon nanocoils on catalyst body 12 is determined from electron microscope images, and a case of a high generation ratio is indicated by ◯, and a case where carbon nanocoils are not generated well is indicated by X. The tar-like byproducts that have been attached to reaction tube 4, exhaust pipe 33 and tar trap 32 are all dissolved and connected in acetone, and the weight of the residue after the acetone has been evaporated is measured, and thereby, the amount of the generation of the tar-like byproducts is measured.

Component analysis was carried out on the tar-like byproducts using an infrared spectrometer (FT-IR-8200PC made by Shimadzu Corporation), and it has turned out that the tar-like byproducts are condensed aromatic rings having a large number of rings originated from acetylene or a substance where highly condensed aromatic rings are connected to each other. In addition, identification tests were carried out on the substance using a mass spectrometer so as to find that the molecular weight of the substance is great, and it has turned out that the substance has a molecular weight at least 1000 or more.

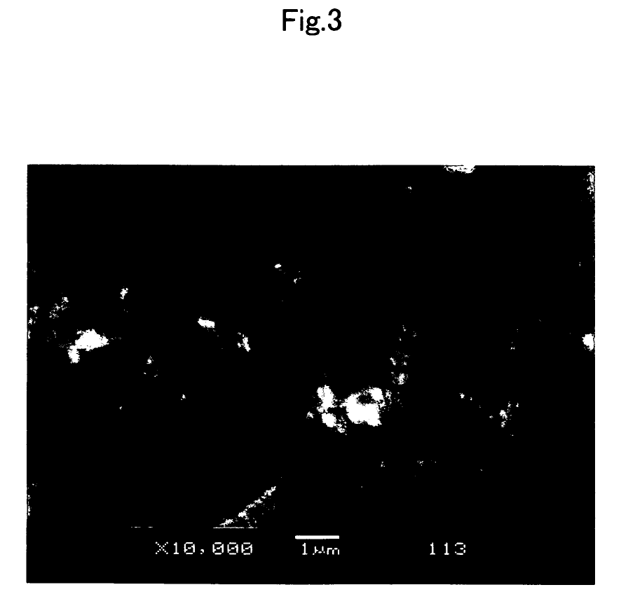

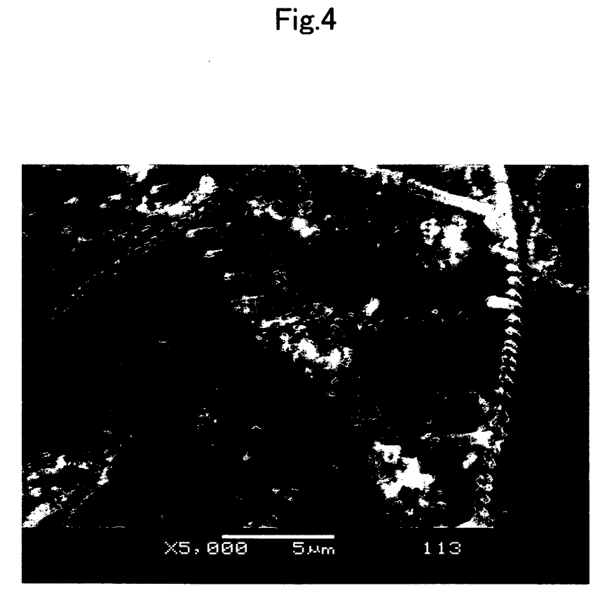

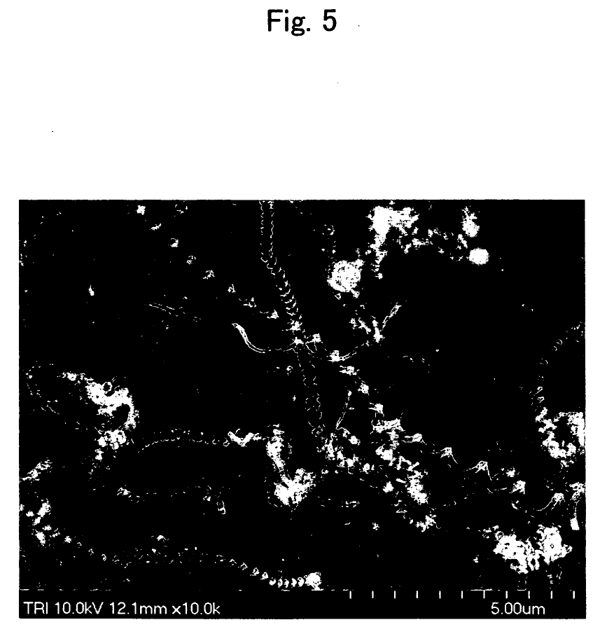

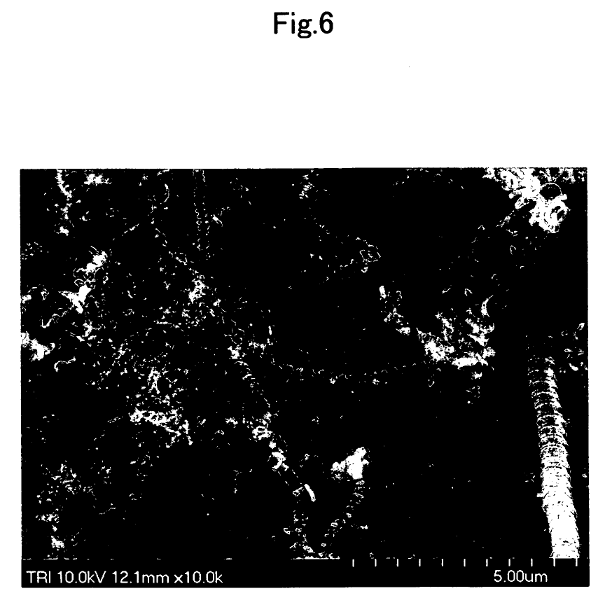

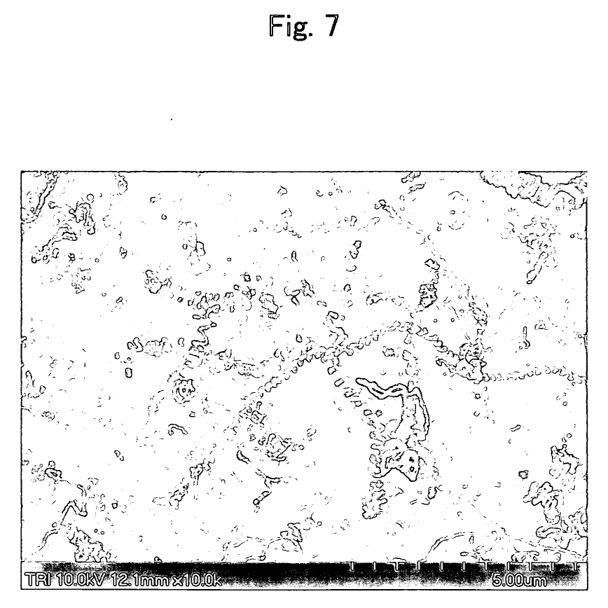

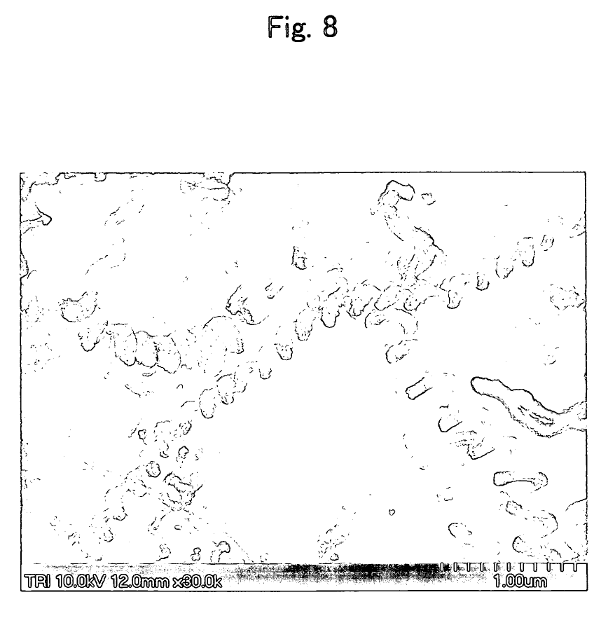

Table 1 lists the results in Conditions 1 to 3. The electron microscope images in Condition 1 are shown in FIGS. 3 and 4, electron microscope images in Condition 2 are shown in FIGS. 5 and 6, and electron microscope images in Condition 3 are shown in FIGS. 7 and 8.

TABLE 1
Examples of synthesis of carbon nanostructures (carbon nanocoils) using material gas nozzle

| | | | C₂H₂ | Generation of | Figure | Tar |
|---|---|---|---|---|---|---|
| Condition | Type of gas | Flow amount | concentration | coils | (Photograph) | amount |
| Condition 1 | Nozzle gas | C₂H₂/He = 30/100 (SCCM) | 1/2 of reference | ◯ | | 0.089 g |
| | Carrier gas | He = 130 (SCCM) | concentration | | | |
| | Concentration of C₂H₂ | 11.5 (vol %) | | | | |
| Condition 2 | Nozzle gas | C₂H₂/He = 15/50 (SCCM) | 1/4 of reference | ◯ | | 0.025 g |
| | Carrier gas | He = 195 (SCCM) | concentration | | | |
| | Concentration of C₂H₂ | 5.8 (vol %) | | | | |
| Condition 3 | Nozzle gas | C₂H₂/He = 8/25 (SCCM) | 1/8 of reference | ◯ | | 0.051 g |
| | Carrier gas | He = 227 (SCCM) | concentration | | | |
| | Concentration of C₂H₂ | 3.1 (vol %) | | | | |
| Common | Carrier gas | He | | | | |
| conditions | Flow rate in reaction | 0.8 cm/s | | | | |
| | tube | | | | | |
| | Temperature in | | | | | |
| | reaction chamber | 700° C. | | | | |
| | Reaction time | 30 min | | | | |

FIG. 3 is an electron microscope image of carbon nanocoils having been magnified 10000 times, which has been obtained in Condition 1 (½ of the reference concentration). FIG. 4 is an electron microscope image of carbon nanocoils having been magnified 5000 times, which has been obtained in Condition 1 (½ of the reference concentration). Both images show well grown carbon nanocoils.

FIG. 5 is an electron microscope image of carbon nanocoils having been magnified 10000 times, which has been obtained in Condition 2 (¼ of the reference concentration). FIG. 6 is an electron microscope image of carbon nanocoils having been magnified 5000 times, which has been obtained in Condition 2 (¼ of the reference concentration). In the same manner as in Condition 1, it can be seen from both images that carbon nanocoils are well grown.

FIG. 7 is an electron microscope image of carbon nanocoils having been magnified 10000 times, which has been obtained in Condition 3 (⅛ of the reference concentration). FIG. 8 is an electron microscope image of carbon nanocoils having been magnified 30000 times, which has been obtained in Condition 3 (⅛ of the reference concentration). In the same manner as in Condition 1, it can also be seen from both images that carbon nanocoils are well grown.

As can be seen from the above, it has been proven that carbon nanocoils grow at a high density using a method and an apparatus of the present invention even when the concentration of C₂H₂ is lowered to ½, ¼ and ⅛ of the reference concentration.

In addition, the amount of the generated tar-like substance varies 0.089 g→0.025 g→0.051 g as the reference concentration becomes ½→¼→⅛ of the reference concentration, and it is found to be extremely small. In addition, the amount of stain of the tar-like substance is extremely small when the appearance of reaction tube 4 is observed, and it has been proven that the stain preventing performance is significantly superior to that of the conventional apparatus.

### COMPARATIVE EXAMPLE

### Synthesis of Carbon Nanocoils Using Conventional Apparatus

In order to compare with Conventional Example 1 where an apparatus of the present invention is utilized, the same carbon nanocoil synthesizing tests were carried out using a conventional apparatus from which material gas supplying pipe 8 had been removed, that is, the apparatus shown in FIG. 19. The structure of the apparatus as well as He and C₂H₂ were exactly the same. The difference is that the concentration of C₂H₂ had been changed.

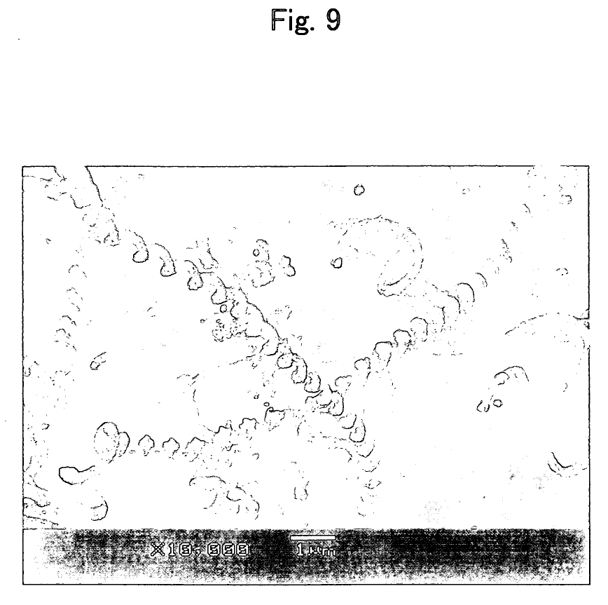

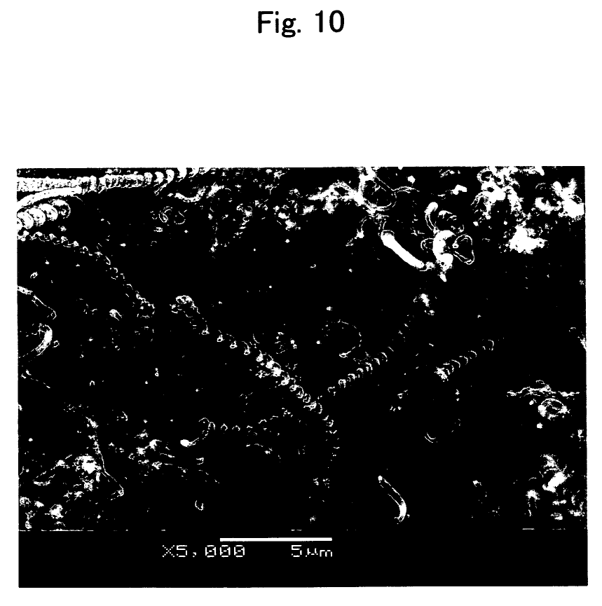

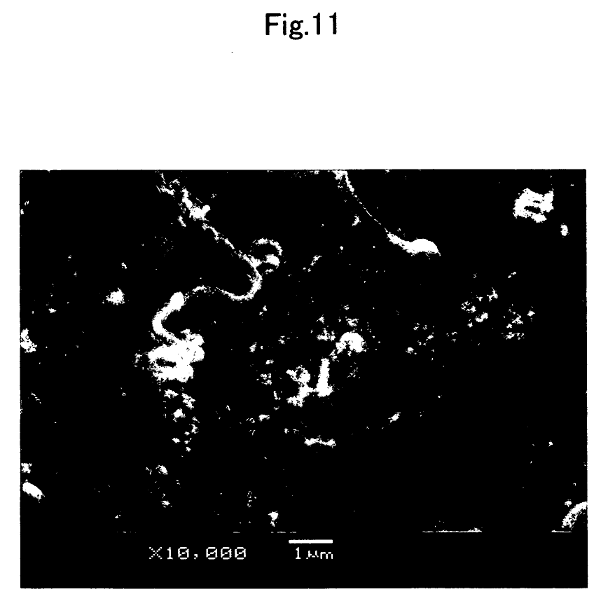

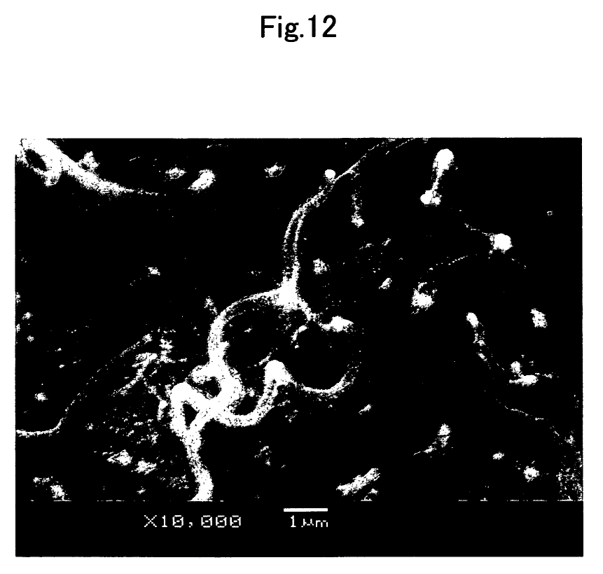

The concentration in Condition 4 is the same as the reference concentration, the concentration in Condition 5 is ⅔ of the reference concentration and the concentration in Condition 6 is ⅓ of the reference concentration. The results are listed in Table 2. The results in Condition 4 are shown in FIGS. 9 and 10, the results in Condition 5 are shown in FIG. 11 and the results in Condition 6 are shown in FIG. 12 as electron microscope images.

TABLE 2
Comparative examples of synthesis of carbon nanostructures (carbon nanocoils) using no material gas nozzle

| | | | | Generation | Figure | |
|---|---|---|---|---|---|---|
| Condition | Type of gas | Flow amount | C₂H₂concentration | of coils | (Photograph) | Tar amount |
| Condition 4 | Carrier gas | He = 260 (SCCM) | Reference | ◯ | | 0.317 g |
| | Concentration of C₂H₂ | 23.0 (vol %) | concentration | | | |
| Condition 5 | Carrier gas | He = 260 (SCCM) | 2/3 of reference | X | | 0.083 g |
| | Concentration of C₂H₂ | 15.3 (vol %) | concentration | | | |
| Condition 6 | Carrier gas | He = 260 (SCCM) | 1/3 of reference | X | | 0.048 g |
| | Concentration of C₂H₂ | 7.7 (vol %) | concentration | | | |
| Common | Carrier gas | He | | | | |
| conditions | Flow rate in reaction | 0.8 cm/s | | | | |
| | tube | | | | | |
| | Temperature in reaction | 700° C. | | | | |
| | chamber | | | | | |
| | Reaction time | 30 min | | | | |

FIG. 9 shows an electron microscope image of carbon nanocoils having been magnified 10000 times, which had been obtained in Condition 4 (same as the reference concentration). FIG. 10 shows an electron microscope image of carbon nanocoils having been magnified 5000 times, which had been obtained in Condition 4 (same as the reference concentration). Carbon nanocoils are well grown and the results of the conventional technique are reproduced.

FIG. 11 shows an electron microscope image of carbon nano-substances having been magnified 10000 times, which had been obtained in Condition 5 (⅔ of the reference concentration). FIG. 12 shows an electron microscope image of carbon nanostructures having been magnified 10000 times, which had been obtained in Condition 6 (⅓ of the reference concentration). These images show that no carbon nanocoils have grown.

It can be seen from these results that carbon nanocoils do not grow in accordance with the conventional method in the conventional apparatus unless the concentration is approximately the same level as the reference concentration, and carbon nanocoils do not grow in the case where the concentration is lower than the reference concentration.

In addition, the weight of the generated tar-like substance is as extremely high as 0.317 g in Condition 4, and is as low as 0.083 g and 0.084 g in Conditions 5 and 6. However, this amount of the generated tar-like substance is much greater than the amount of the generated tar-like substance in Conditions 1 to 3 shown in Table 1. This state can be seen from the inner surface of reaction tube 4 being blackened.

Accordingly, it has been proven that carbon nanocoils can be generated without fail using the method and the apparatus of the present invention even when the concentration of C₂H₂ becomes lower than the reference concentration, and the amount of the generated tar-like substance can be significantly reduced as a result of the improvement.

### EXAMPLE 2

### Carbon Nanotubes

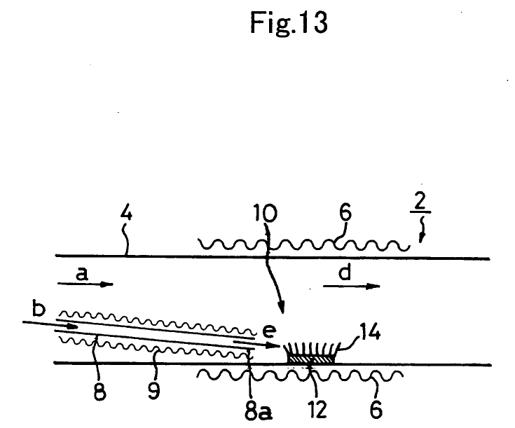

FIG. 13 is a schematic diagram showing the configuration of a highly efficient material spraying type carbon nanostructure synthesizing apparatus according to the present invention in the case where it is used for the synthesis of carbon nanotubes. This apparatus is a highly efficient material spraying type carbon nanostructure synthesizing apparatus 2 which is exactly the same as that of Example 1, but a catalyst body 12, the temperature of the reaction region, the temperature of the material gas supplying pipe, the material gas and the carrier gas are different.

The first difference is that a catalyst where Ni is sintered in highly pure γ-alumina pellets (99.95% or more) of which the sodium content is 0.01% or less is used as catalyst body 12. The second difference is that the temperature of the reaction region is maintained at 500° C. The third difference is that the temperature of the material gas supplying pipe is maintained at 250° C. In addition, the fourth difference is that CH₄ is utilized as a material gas and Ar is used as a carrier gas.

As described above, carbon nanotubes are generated on the Ni metal containing highly pure alumina pellet catalyst at 400° C. or more, and a tar-like substance is generated in a temperature range of 250° C. to 400° C. Accordingly, the temperature of the reaction region is set at 500° C., and the temperature of the material gas supplying pipe is set at 250° C.

As shown in FIG. 13, carbon nanotubes grew on the surface of catalyst body 12 with high density, and almost no tar-like byproducts were observed on the inner surface of reaction tube 4. Excellent working effects were clearly observed in accordance with the method of the present invention and in the apparatus of the present invention using material gas supplying pipe 8 and heater 9 for heating the supplying pipe.

The present invention is not limited to the synthesis of carbon nanocoils and carbon nanotubes, but rather, can be utilized for the synthesis of a wide range of carbon nanostructures, including carbon nanotubes with beads, carbon nano-brushes and fullerene.

### EXAMPLE 3

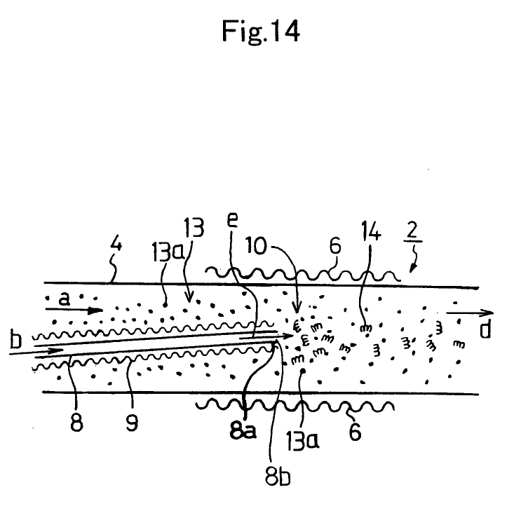

FIG. 14 is a schematic diagram showing the configuration of a highly efficient material spraying type carbon nanostructure synthesizing apparatus according to the present invention in the case where a catalyst powder is used as the catalyst body. Though in FIG. 14, catalyst body 12 of FIG. 1 is formed of a catalyst structure, a catalyst powder 13 is made to flow in the direction of arrow a in Example 3. When catalyst powder 13 flows into a reaction region 10, it is heated to the temperature for generating carbon nanostructures by heater 6 for heating the reaction region while a material gas is sprayed against catalyst powder 13 from material gas spraying nozzle 8b so that carbon nanostructures 14 grow on the surface of catalyst powder forming particles 13a.

Material gas supplying pipe 8 is placed so that material gas spraying nozzle 8b reaches reaction region 10, heater 9 for the material gas supplying pipe is placed around material gas supplying pipe 8, and the entirety of material gas supplying pipe 8 is heated to and maintained within a temperature range where no tar-like substance is generated.

### EXAMPLE 4

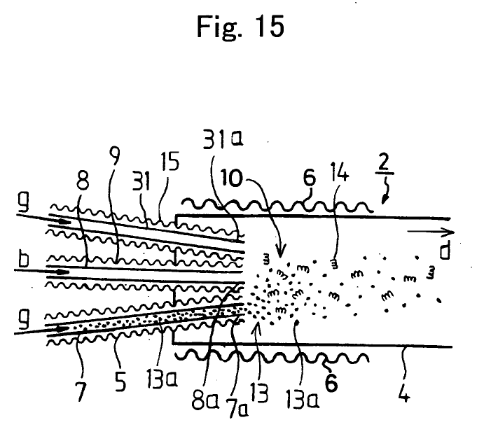

FIG. 15 is a schematic diagram showing the configuration in a case where a highly efficient material spraying type carbon nanostructure synthesizing apparatus according to the present invention is provided with a catalyst powder supplying pipe. In FIG. 15, a catalyst powder supplying pipe 7 and a carrier gas supplying pipe 31, in addition to material gas supplying pipe 8, are provided, and the supplying pipes are provided with a heater 9 for the material gas supplying pipe, a heater for the catalyst powder supplying pipe and a heater for the carrier gas supplying pipe, respectively. The heater for the material gas supplying pipe heats the entirety of material gas supplying pipe 8 to a temperature region where no tar-like substance is generated and maintains it at this temperature, in the same manner as in the other examples. In addition, heater 5 for the catalyst powder supplying pipe heats catalyst powder supplying pipe 7 to the temperature for generating carbon nanostructures, and therefore, catalyst powder 13 is supplied to reaction region 10 at the temperature for generating carbon nanostructures. Thus, carbon nanostructures immediately start growing when the material gas is sprayed against the catalyst powder.

Furthermore, in FIG. 15, a carrier gas supplying pipe 31 is also provided, and the carrier gas can be heated to a predetermined temperature. When the carrier gas is heated, reaction region 10 is maintained at an even temperature, so that carbon nanostructures can be generated in a stable manner.

### EXAMPLE 5

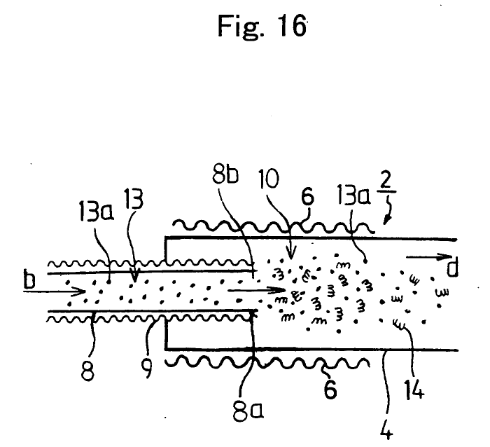

FIG. 16 is a schematic diagram showing a case where a highly efficient material spraying type carbon nanostructure synthesizing apparatus according to the present invention is provided with a mixed gas supplying pipe. In FIG. 16, the material gas and catalyst powder 13 are mixed and supplied to reaction region 10. The mixture of the material gas and catalyst powder 13 is adjusted to an appropriate ratio. Furthermore, the mixed gas is preheated by heater 9 for the mixed gas supplying pipe so that the material gas and catalyst powder 13 become of the same temperature, so that the mixed gas is immediately heated to the temperature region for the generation of carbon nanostructures upon being introduced into reaction region 10, and thus, carbon nanostructures 14 are generated.

### EXAMPLE 6

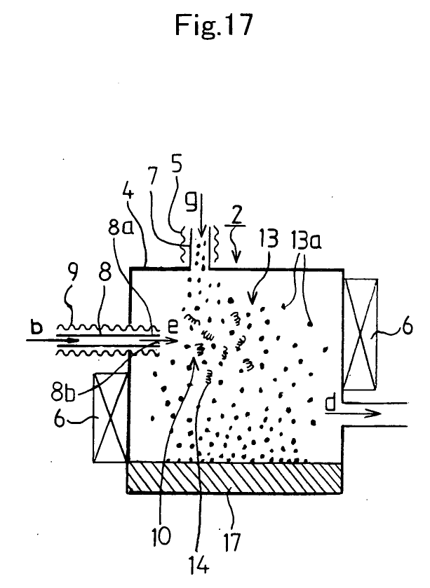

FIG. 17 is a schematic diagram showing the configuration of a case where a stirring unit 17 is attached to highly efficient material spraying type carbon nanostructure synthesizing apparatus 2 according to the present invention. In FIG. 17, stirring unit 17 for stirring catalyst powder 13 in the reaction region 10 is attached, and a material gas is sprayed against catalyst powder 13 while being stirred in the configuration. Stirring unit 17 is formed of vibration means using ultrasonic vibration or the like, rotation means for rotating a rotational plate or a container to which a catalyst powder is supplied, fluctuation means for causing fluctuation movements through a fluctuation plate that is provided within the reaction region, or any other known means. Furthermore, the system can be used either in the case of an intermittent operation where a predetermined amount of catalyst powder 13 is deposited in carbon nanostructure reaction region 10 to which the stirring unit of Example 6 is attached, and after that, catalyst powder 13 is stirred, or in the case of continuous operation where the catalyst powder 13 is stirred while being supplied.

### EXAMPLE 7

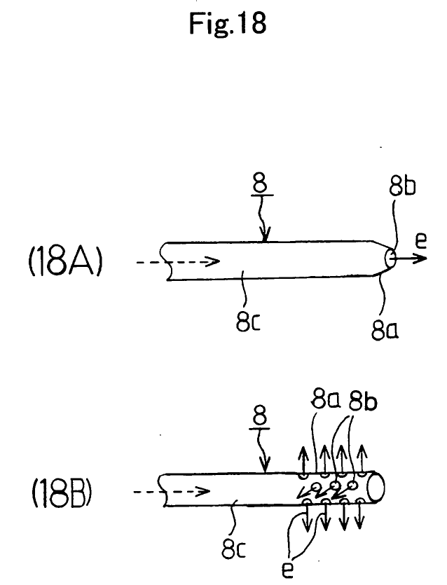

FIG. 18 is a schematic diagram showing the configuration of each gas supplying pipe 8, as well as the gas spraying nozzle thereof, according to the present invention. FIG. 18A is a schematic diagram showing the configuration of a gas supplying tube 8 in nozzle form. A gas spraying nozzle 8b is formed at an end 8a of each gas supplying pipe (material gas supplying pipe, catalyst supplying pipe or carrier gas supplying pipe), and a gas is supplied from this gas spraying nozzle 8b to reaction region 10. In FIG. 18A, end 8a is formed so as to be in taper form, so that a supplied gas can be sprayed against reaction region 10 more efficiently.

FIG. 18B is a schematic diagram showing the configuration of a gas supplying pipe 8 where gas spraying nozzles 8b are provided around the outer periphery. In FIG. 18B, a plurality of spraying nozzles 8b are provided around the outside of an end 8a of the supplying pipe, so that a material gas and/or a catalyst powder 13 diffuse in the reaction region 10. Accordingly, the probability of the material gas making contact with catalyst powder 13 increases, and thus, carbon nanostructures 14 can be generated highly efficiently. The gas supplying pipes which are used in Examples 1 to 6 are not limited to the form shown in FIG. 18, and known gas supplying pipes having a variety of forms, depending on the purpose, as well as the gas spraying nozzles thereof, can be used.

The present invention is not limited to the aforementioned examples and, of course, includes within its technical scope a variety of modifications and different designs falling within a scope where the technological idea of the present invention is not deviated from.

### INDUSTRIAL APPLICABILITY

According to the first mode of the present invention, it has been found, as a result of research by the present inventors, that tar-like byproducts are generated through the decomposition and combination of a material gas during the process where the temperature gradually increases from a low temperature to the temperature where carbon nanostructures are generated. That is, the subject matter of the present invention is to remove a middle temperature range where the material gas decomposes and combines from the reaction process. Therefore, according to the present invention, the material gas is maintained at a temperature region where no tar-like byproducts are generated (temperature that is lower than the middle temperature range; room temperature or lower), and it becomes possible to greatly reduce the generation of tar-like byproducts by introducing this material gas directly into the temperature region for generating carbon nanostructures, skipping the middle temperature. In addition, the material gas can be directly sprayed against the reaction region, and therefore, the probability of the catalyst body reacting with the material gas increases in the reaction region. Thus, the yield in the generation of carbon nanostructures can be greatly increased. Furthermore, the catalyst body may be fixed in the reaction region so that the material gas is sprayed against this catalyst body, or the catalyst body may be supplied to the reaction region from a catalyst body tank or the like, if necessary.

According to the second mode of the present invention, the material gas is preheated to within a temperature range where no tar-like byproducts are generated according to the present invention, and the temperature of this preheated material gas is increased directly to the temperature for the generation of carbon nanostructures, skipping the middle temperature range, and thereby, the generation of tar-like byproducts can be greatly reduced. This is different from the first invention in that the material gas is preheated. The reactivity of the material gas can be increased as a result of this preheating, and thereby, the probability of the material gas reacting in the catalyst region can be increased to a great degree. In addition, the material gas is directly sprayed toward the reaction region, and therefore, the probability of the catalyst body reacting with the material gas increases in the reaction region, so that the density of generation and the efficiency of generation of carbon nanostructures can be greatly increased. Furthermore, the catalyst body is fixed in the reaction region, and a material gas may be sprayed against this catalyst body, or the catalyst body may be supplied to the reaction region from a catalyst body tank or the like, if necessary.

According to the third mode of the present invention, the catalyst body is formed of catalyst structures, and thereby, it is possible to provide the catalyst body only in the reaction region. Therefore, the catalyst body and the material gas can be made to react highly efficiently. Furthermore, carbon nanostructures are formed on the surface of the catalyst structures, and therefore, carbon nanostructures can be collected highly efficiently from these catalyst structures.

According to the fourth mode of the present invention, the structure of the catalyst structure can be selected on the basis of the type of the catalyst structures of the carbon nanostructures to be synthesized. Catalyst structures having a structure in layer form, a structure in grate form, a porous structure or a structure in fiber form of which the surface area is great are used, and thereby, carbon nanostructures can be generated highly efficiently. Furthermore, carbon nanostructures can be easily collected by using a catalyst structure having a plate form structure.

According to the fifth mode of the present invention, the catalyst body is formed of a catalyst powder, and thereby, the catalyst body can be easily supplied when necessary. Furthermore, the carbon nanostructures that have been formed on the surface of the particles that form the catalyst powder can be easily collected by making the catalyst powder flow out.

According to the sixth mode of the present invention, the catalyst powder can be supplied into the reaction region, if necessary, so that the material gas and the catalyst powder can be made to react highly efficiently.

According to the seventh mode of the present invention, a highly efficient material spraying type carbon nanostructure synthesizing method for supplying the catalyst powder into the space that has been heated to within the temperature range for the generation of carbon nanostructures through a catalyst powder supplying pipe is provided. The catalyst powder is supplied through the catalyst powder supplying pipe, and thereby, an appropriate amount that is required can be supplied to the reaction region. Furthermore, the catalyst powder supplying pipe is heated, and thereby, the catalyst powder that has been heated to within the temperature range for generating carbon nanostructures can be supplied so as to immediately react with the material gas.

According to the eighth mode of the present invention, the mixture of the material gas to a catalyst powder is adjusted to an appropriate ratio, and thereby, carbon nanostructures can be synthesized highly efficiently. Furthermore, the mixed gas is heated, and thereby, the material gas and the catalyst powder can be preheated to the same temperature in such a manner that the mixed gas is instantly heated to the temperature range for the generation of carbon nanostructures upon being introduced into the reaction region, and thus, carbon nanostructures can be synthesized highly efficiently.

According to the ninth mode of the present invention, the catalyst powder is stirred, and thereby, the material gas and the catalyst powder can be efficiently made to make contact with each other. Thus, carbon nanostructures can be synthesized highly efficiently. As for the stirring method, a vibration method using ultrasonic vibration, a rotation method for rotating a rotational plate or the container into which the catalyst powder is supplied, a fluctuation method for causing fluctuation in the reaction region to which a fluctuation plate has been attached, or other known methods can be used.

According to the tenth mode of the present invention, the temperature where tar-like byproducts are generated from, for example, hydrocarbon that is utilized as the material gas, is 300° C. to 600° C., and the temperature where carbon nanostructures are generated from the hydrocarbon slightly varies, depending on the type of catalyst, but is 550° C. or more, and is assumed to be 600° C. to 1200° C. for high efficiency. Accordingly, the preheated temperature of the material gas is controlled so as to be 300° C. or less, and this preheated material gas is instantly sent into the reaction region at 600° C. or more, and the material gas does not then pass through the temperature range where tar-like byproducts are generated, and therefore, theoretically, no tar-like byproducts are generated.

According to the eleventh mode of the present invention, the temperature of the material gas is in a temperature range where no tar-like byproducts are generated, and therefore, no tar-like byproducts are generated inside the material gas supplying pipe. In addition, this material gas is directly sprayed against the catalyst body from the material gas spraying nozzle in the structure, and therefore, there is a high probability that the material gas will make contact with the catalyst so as to be efficiently converted to carbon nanostructures. Thus, generation of tar-like byproducts can be greatly reduced. Most of the material gas is consumed during the reaction with the catalyst, and therefore, generation of the tar-like substance in the reaction tube can be strongly suppressed.

According to the twelfth mode of the present invention, no tar-like products are generated inside the material gas supplying pipe in the preheated temperature range, and the preheated material gas is directly sprayed against the catalyst body from the material gas spraying nozzle in the structure, and therefore, there is a high probability that the preheated material gas will make contact with the catalyst, so that carbon nanostructures are synthesized highly efficiently. Accordingly, most of the material gas is consumed during the reaction with the catalyst, in the same manner as in the aforementioned unit, and therefore, generation of a tar-like substance in the reaction tube can be prevented.

According to the thirteenth mode of the present invention, no tar-like products are generated inside the mixed gas supplying pipe in the preheating temperature range. The preheated mixed gas that has flown into the reaction region from the mixed gas spraying nozzle is instantly heated to a temperature for generating carbon nanostructures where the material gas and the catalyst body that form the mixed gas are simultaneously heated to the same temperature, and the preheated mixed gas is directly sprayed against the catalyst body in the structure. Therefore, there is a high probability that the preheated material gas will make contact with the catalyst so that carbon nanostructures can be synthesized highly efficiently. Accordingly, in the same manner as in the aforementioned unit, most of the material gas is consumed during the reaction with the catalyst, and therefore, generation of a tar-like substance can be prevented in the reaction tube.

According to the fourteenth mode of the present invention, a catalyst body is supplied to the reaction region through the catalyst supplying pipe for supplying the catalyst body, and thereby, a necessary amount of catalyst powder can be supplied. Furthermore, the catalyst body is preheated by the preheating unit, and thereby, the catalyst body that was supplied to the reaction region instantly reaches the temperature for generating carbon nanostructures and can react with the material powder.

According to the fifteenth mode of the present invention, the catalyst powder is stirred, and thereby, the material gas can be efficiently made to make contact with the catalyst powder, so that carbon nanostructures are synthesized highly efficiently. The stirring unit can be formed of vibration means using ultrasonic vibration, rotational means for rotating a rotational plate or a container to which a catalyst powder is supplied, fluctuation means for causing fluctuation movements in the reaction region to which a fluctuation plate that is attached, or other known means. Furthermore, a predetermined amount of a catalyst body may be stirred after the catalyst body has been deposited in the reaction region, or the catalyst body may be stirred while being supplied.

According to the sixteenth mode of the present invention, carbon nanocoils can be selectively generated from hydrocarbon using a catalyst for the synthesis of carbon nanocoils, and therefore, the amount of tar-like byproducts can be reduced, and at the same time, carbon nanocoils can be highly efficiently synthesized with high density. As the catalyst for the synthesis of carbon nanocoils, a metal carbide catalyst that contains a transition metal element, a metal oxide catalyst or a metal-based catalyst can be used. Transition metal element refers to the transition elements shown in the periodic table, and concrete examples thereof include Sc to Cu in the fourth period, Y to Ag in the fifth period, and La to Au in the sixth period. When an element that has been selected from the transition metal elements is referred to as A, as the metal carbide, AInC, ASnC, AInSnC and the like can be used as the catalyst for the synthesis of carbon nanostructures. Furthermore, as the metal oxide, AInO, ASnO, AInSnO, AAlSnO and ACrSnO can be used as the catalyst for the synthesis of carbon nanostructures, and as the metal-based catalyst, AAlSn, ACrSn and AInSn can be used. Furthermore, as an appropriate metal catalyst, a metal catalyst that contains an Fe element in a transition metal element can be used as the catalyst for the synthesis of carbon nanostructures. Concretely, an Fe-based metal carbide catalyst such as FeₓIn_{y}C_{z}, FeₓSn_{y}C_{z} and FeₓIn_{y}C_{z}Sn_{w} can be used as the catalyst for the synthesis of carbon nanostructures, and a preferable composition ratio for the metal carbide catalyst is Fe₃InC_{0.5}, Fe₃SnC or Fe₃In₁₋ᵥC_{0.5}Sn_{w} (0≦v<1, w≧0). Furthermore, as the catalyst for the synthesis of carbon nanostructures, an Fe-based metal catalyst, such as FeₓIn_{y}Sn_{z}, FeₓAl_{y}Sn_{z} or FeₓCr_{y}Sn_{z} can be used, and a preferable composition ratio is Fe₃In_{y}Sn_{z} (y≦9, z≦3), FeₓAl_{y}Sn_{z} (y≦1, z≦3) or FeCr_{y}Sn_{z} (y≦1, z≦3). A catalyst body is selected from among these metal catalysts on the basis of the purpose, and thereby, carbon nanostructures can be generated with high efficiency.

According to the seventeenth mode of the present invention, a highly efficient material spraying type carbon nanostructure synthesizing method where a material gas includes at least one of acetylene, allylene, ethylene, benzene or toluene, and alcohol or methane is provided. This material gas from among hydrocarbon material gases is appropriate particularly in the case where carbon nanostructures are generated, which allows for mass production of carbon nanostructures without generating tar-like byproducts.

According to the eighteenth mode of the present invention, a highly efficient material spraying type carbon nanostructure synthesizing method where carbon nanostructures are carbon nanocoils, carbon nanotubes, carbon nano-twists, carbon nanotubes with beads, carbon nano-brushes or fullerene is provided. Specific carbon nanostructures can be selectively mass produced by changing the type of catalyst body, or by adjusting the temperature for the generation of carbon nanostructures in the reaction region so that it varies.

1. A highly efficient material spraying type carbon nanostructure synthesizing method for synthesizing carbon nanostructures from a material gas in accordance with a catalyst chemical vapor deposition method, wherein a material gas of which the temperature is in a range where no tar-like byproducts are generated is sprayed so as to make contact with a catalyst body in a space that has been heated to within a temperature range for the generation of carbon nanostructures, so that carbon nanostructures are generated.

2. A highly efficient material spraying type carbon nanostructure synthesizing method for synthesizing carbon nanostructures from a material gas in accordance with a catalyst chemical vapor deposition method, wherein a material gas of which the temperature is preheated to within a range where no tar-like byproducts are generated is directly sprayed so as to make contact with a catalyst body in a space that has been heated to within a temperature range for the generation of carbon nanostructures, so that carbon nanostructures are generated.

3. The highly efficient material spraying type carbon nanostructure synthesizing method according to claim 1 or 2, wherein said catalyst body is formed of a catalyst structure.

4. The material spraying type carbon nanostructure synthesizing method according to claim 3, wherein said catalyst structure has at least one or more structures from among a structure in plate form, a structure in layered form, a structure in grate form, a porous structure and a structure in fiber form.

5. The highly efficient material spraying type carbon nanostructure synthesizing method according to claim 1 or 2, wherein said catalyst body is formed of a catalyst powder.

6. The highly efficient material spraying type carbon nanostructure synthesizing method according to claim 5, wherein said catalyst powder is supplied to a reaction region in the space that has been heated to within the temperature range for the generation of carbon nanostructures and, then, is heated to within said temperature range for the generation of carbon nanostructures.

7. The highly efficient material spraying type carbon nanostructure synthesizing method according to claim 5, wherein said catalyst powder is supplied from a catalyst powder supplying pipe into the space that has been heated to within said temperature range for the generation of carbon nanostructures.

8. The highly efficient material spraying type carbon nanostructure synthesizing method according to claim 5, wherein a material gas into which said catalyst powder is mixed is sprayed into the space that has been heated to within said temperature range for the generation of carbon nanostructures.

9. The highly efficient material spraying type carbon nanostructure synthesizing method according to claim 5, wherein said material gas is sprayed against a catalyst powder inside the space that has been heated to within said temperature range for the generation of carbon nanostructures while this catalyst powder is being stirred.

10. The highly efficient material spraying type carbon nanostructure synthesizing method according to claim 2, wherein the temperature of the preheated material gas is set at 300° C. or less.

11. A highly efficient material spraying type carbon nanostructure synthesizing apparatus for synthesizing carbon nanostructures from a material gas in accordance with a catalyst chemical vapor deposition method, wherein a heating unit for heating a reaction region to within a temperature range for the generation of carbon nanostructures is provided, and a material gas supplying pipe for introducing a material gas into the reaction region is provided in such a manner that a material gas spraying nozzle thereof is placed within the reaction region, so that a material gas that is in a temperature range where no tar-like byproducts are generated is sprayed from said material gas spraying nozzle against a catalyst body.

12. A highly efficient material spraying type carbon nanostructure synthesizing apparatus for synthesizing carbon nanostructures from a material gas in accordance with a catalyst chemical vapor deposition method, wherein a heating unit for heating a reaction region to within a temperature range for the generation of carbon nanostructures is provided, a material gas supplying pipe for introducing a material gas into the reaction region is provided in such a manner that a material gas spraying nozzle thereof is placed within the reaction region, and a preheating unit for preheating said material gas supplying pipe to within a temperature range where no tar-like products are generated from the material gas is formed so that a preheated material gas is sprayed from said material gas spraying nozzle against a catalyst body.

13. A highly efficient material spraying type carbon nanostructure synthesizing apparatus for synthesizing carbon nanostructures from a material gas in accordance with a catalyst chemical vapor deposition method, wherein a heating unit for heating a reaction region to within a temperature range for the generation of carbon nanostructures is provided, a mixed gas supplying pipe for introducing a mixed gas of a material gas and a catalyst body into the reaction region is provided in such a manner that a mixed gas spraying nozzle thereof is placed within the reaction region, and a preheating unit for preheating said mixed gas supplying pipe to within a temperature range where no tar-like products are generated from the mixed gas is provided so that a preheated mixed gas is sprayed into the reaction region.

14. The highly efficient material spraying type carbon nanostructure synthesizing apparatus according to claim 11 or 12, wherein a catalyst body supplying pipe for supplying a catalyst body to said reaction region is placed, and a preheating unit for preheating this catalyst body supplying pipe is provided, so that said material gas is sprayed against a preheated catalyst body.

15. The highly efficient material spraying type carbon nanostructure synthesizing apparatus according to claim 11 or 12, wherein a stirring unit for stirring a catalyst body in said reaction region is provided, and a material gas is sprayed against a catalyst body while the catalyst body is being stirred.

16. The highly efficient material spraying type carbon nanostructure synthesizing method according to claim 1 or 2, wherein said catalyst body is a catalyst for the synthesis of carbon nanocoils.

17. The highly efficient material spraying type carbon nanostructure synthesizing method according to claim 1 or 2, wherein the material gas includes at least one of acetylene, allylene, ethylene, benzene or toluene, and alcohol or methane.

18. The highly efficient material spraying type carbon nanostructure synthesizing method according to claim 1 or 2, wherein said carbon nanostructures are carbon nanocoils, carbon nanotubes, carbon nano-twists, carbon nanotubes with beads, carbon nano-brushes or fullerene.
